(19) United States
(12) Patent Application Publication
(10) Pub. No.: US 2026/0161436 A1
(43) Pub. Date: Jun. 11, 2026

(54) SYSTEM AND METHOD FOR REMOTE DATA GATEWAY PROTOCOL IN A MULTI-TENANT ENVIRONMENT FOR USE WITH A DATA ANALYTICS WAREHOUSE

(71) Applicant: ORACLE INTERNATIONAL CORPORATION, Redwood Shores, CA (US)

(72) Inventors: MANISH BARMAN, Pleasanton, CA (US); SAMBIT NANDA, San Ramon, CA (US); SUNIL RAJ, Bengaluru (IN); VIBHAS GOYAL, Bengaluru (IN)

(21) Appl. No.: 19/407,444

(22) Filed: Dec. 3, 2025

Related U.S. Application Data
(60) Provisional application No. 63/729,229, filed on Dec. 6, 2024.

(51) Int. Cl. G06F 9/455; H04L 12/66

(52) U.S. Cl. CPC G06F 9/455; H04L 12/66; G06F 2009/4557; G06F 2009/45595

(57) ABSTRACT

In accordance with an embodiment, described herein are systems and methods for providing a remote data gateway protocol in a multi-tenant environment, for use with data analytics warehouses or other computing environments. In accordance with an embodiment, the remote data gateway enables secure access by a data analytics warehouse, operating in a cloud environment, to a customer's data. The system supports routing of requests and achieves comprehensive connectivity in multi-tenant environments, through tenancy-binding using a combination of consistent-hashing and cluster subsets in the load balancer. In accordance with an embodiment that includes a Kubernetes microservices environment, the use of a consistent-hashing scheme, in combination with specific keys in the header to determine which subset of pods to connect to, can be used to maintain, for the duration of processing several requests from multiple tenants, a connection to each of one or more microservice pods simultaneously.

### CLAIM OF PRIORITY AND CROSS-REFERENCE TO RELATED APPLICATIONS

The present application claims the benefit of priority to U.S. Provisional Patent Application titled “SYSTEM AND METHOD FOR REMOTE DATA GATEWAY PROTOCOL IN A MULTI-TENANT ENVIRONMENT FOR USE WITH A DATA ANALYTICS WAREHOUSE”, Application No. 63/729,229, filed Dec. 6, 2024; and is related to U.S. patent application Ser. No. 17/376,871, titled “REMOTE DATA GATEWAY FOR USE WITH A DATA ANALYTICS WAREHOUSE”, filed on Jul. 15, 2021, published as U.S. Patent Application Publication No. 2022/0100751, and subsequently issued as U.S. Pat. No. 11,899,679 on Feb. 13, 2024; and U.S. patent application Ser. No. 17/376,879, titled “REMOTE DATA GATEWAY WITH SUPPORT FOR PEER-TO-PEER ROUTING FOR USE WITH A DATA ANALYTICS WAREHOUSE”, filed on Jul. 15, 2021, published as U.S. Patent Application Publication No. 2022/0100773, and subsequently issued as U.S. Pat. No. 11,741,120 on Aug. 29, 2023; each of which above-referenced patent applications and patents and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to computer data analytics, and computer-based methods of providing business intelligence or other types of data, and are particularly related to systems and methods for providing a remote data gateway protocol in a multi-tenant environment for use with a data analytics warehouse.

### BACKGROUND

Generally described, within an organization, data analytics enables the computer-based examination or analysis of large amounts of data, in order to derive conclusions or other information from that data; while business intelligence tools provide an organization's business users with information describing their enterprise data in a format that enables those business users to make strategic business decisions.

Increasingly, there is an interest in developing software applications that leverage the use of data analytics within the context of an organization's enterprise software application or data environment, such as, for example, an Oracle Fusion Applications environment or other type of enterprise software application or data environment; or within the context of a software-as-a-service (SaaS) or cloud environment, such as, for example, an Oracle Analytics Cloud or Oracle Cloud Infrastructure environment, or other type of cloud environment.

### SUMMARY

In accordance with an embodiment, described herein are systems and methods for providing a remote data gateway protocol in a multi-tenant environment, for use with data analytics warehouses or other computing environments.

In accordance with an embodiment, the remote data gateway enables secure access by a data analytics warehouse, operating in a cloud environment, to a customer's data. The system supports routing of requests and achieves comprehensive connectivity in multi-tenant environments, through tenancy-binding using a combination of consistent-hashing and cluster subsets in the load balancer.

In accordance with an embodiment that includes a Kubernetes microservices environment, the use of a consistent-hashing scheme, in combination with specific keys in the header to determine which subset of pods to connect to, can be used to maintain, for the duration of processing several requests from multiple tenants, a connection to each of one or more microservice pods simultaneously.

### BRIEF DESCRIPTION OF THE DRAWINGS

FIG. 1 illustrates an example of an analytics environment, in accordance with an embodiment.

FIG. 2 illustrates the use of a remote data gateway with an analytics environment, in accordance with an embodiment.

FIG. 3 further illustrates the use of a remote data gateway with an analytics environment, in accordance with an embodiment.

FIG. 4 further illustrates the use of a remote data gateway with an analytics environment, in accordance with an embodiment.

FIG. 5 illustrates an example sequence diagram associated with the use of a remote data gateway with an analytics environment, in accordance with an embodiment.

FIG. 6 illustrate an example sequence diagram associated with the use of a remote data gateway with an analytics environment, in accordance with an embodiment.

FIG. 7 illustrates a process for use of a remote data gateway with an analytics environment, in accordance with an embodiment.

FIG. 8 illustrates an example data analytics environment (e.g., an OAC cluster), in accordance with an embodiment.

FIG. 9 illustrates providing a remote data gateway protocol in a multi-tenant environment for use with a data analytics warehouse, in accordance with an embodiment.

FIG. 10 further illustrates providing a remote data gateway protocol in a multi-tenant environment, in accordance with an embodiment.

FIG. 11 further illustrates providing a remote data gateway protocol in a multi-tenant environment, in accordance with an embodiment.

FIG. 12 further illustrates providing a remote data gateway protocol in a multi-tenant environment, in accordance with an embodiment.

FIG. 13 illustrates an example sequence diagram associated with providing a remote data gateway protocol in a multi-tenant environment, in accordance with an embodiment.

FIG. 14 illustrates an example sequence diagram associated with providing a remote data gateway protocol in a multi-tenant environment, in accordance with an embodiment.

FIG. 15 illustrates an example sequence diagram associated with providing a remote data gateway protocol in a multi-tenant environment, in accordance with an embodiment.

FIG. 16 illustrates an example use of an additional BI filter in providing a remote data gateway protocol in a multi-tenant environment, in accordance with an embodiment.

FIG. 17 illustrates a process for providing a remote data gateway protocol in a multi-tenant environment, in accordance with an embodiment.

### DETAILED DESCRIPTION

As described above, within an organization, data analytics enables the computer-based examination or analysis of large amounts of data, in order to derive conclusions or other information from that data; while business intelligence tools provide an organization's business users with information describing their enterprise data in a format that enables those business users to make strategic business decisions.

Increasingly, there is an interest in developing software applications that leverage the use of data analytics within the context of an organization's enterprise software application or data environment, such as, for example, an Oracle Fusion Applications environment or other type of enterprise software application or data environment; or within the context of a software-as-a-service (SaaS) or cloud environment, such as, for example, an Oracle Analytics Cloud or Oracle Cloud Infrastructure environment, or other type of cloud environment.

Current versions of Oracle Analytics Cloud (OAC) employ a large number of single-tenant monolithic instances. In such environments, the components may be scaled even if little/not used by the customer. Complex upgrades must be run on each instance separately; and overall, it can be costly to maintain/enhance autonomy, density, elastic scaling, and resilient ZDT upgrades.

Increasingly, such environments are intended to support multiple tenants or customers. In such environments, services may be designed to be stateless, i.e., to provide a separation of functionality versus data. This allows a single/same service to support multiple tenants/customers, at the same time, and with appropriate secure data separation.

In accordance with an embodiment, a remote data gateway (RDG) server, for example an Oracle Data Gateway instance, enables secure access by the data analytics environment to a customer's on-premise data, without migrating the on-premise data to the cloud. The RDG server can expose a port, which an RDG agent connects to for job requests, for example to provide on-premise data to the cloud environment, or to run data analytics on the on-premise data.

Such an RDG protocol generally operates as an asynchronous protocol, in that the RDG agent executes jobs as part of processing a request, and submits a response or results through an out-of-band asynchronous connection to the same RDG server. In such environment, the system needs to ensure that a response goes back to where the request was originally picked up; and that an RDG agent can only pick up jobs for tenants/customers associated with the agent.

However, while some RDG implementations address this by using a common job store, this can result in reduced performance or inefficiency. In other RDG implementations, although peer-to-peer routing can be used to improve performance for a single tenant/customer, such an approach is typically not as efficient when supporting multiple tenants/customers.

In accordance with an embodiment, described herein are systems and methods for providing a remote data gateway protocol in a multi-tenant environment, for use with data analytics warehouses or other computing environments.

In accordance with an embodiment, the remote data gateway enables secure access by a data analytics warehouse, operating in a cloud environment, to a customer's data. The system supports routing of requests and achieves comprehensive connectivity in multi-tenant environments, through tenancy-binding using a combination of consistent-hashing and cluster subsets in the load balancer.

In accordance with an embodiment that includes a Kubernetes microservices environment, the use of a consistent-hashing scheme, in combination with specific keys in the header to determine which subset of pods to connect to, can be used to maintain, for the duration of processing several requests from multiple tenants, a connection to each of one or more microservice pods simultaneously.

### Data Analytics Environments

In accordance with an embodiment, an analytics environment, or data warehouse environment or component, such as, for example, an Oracle Autonomous Data Warehouse (ADW), Oracle Autonomous Data Warehouse Cloud (ADWC), or other type of data warehouse environment or component adapted to store large amounts of data, can provide a central repository for storage of data collected by one or more business applications.

For example, in accordance with an embodiment, the data warehouse environment or component can be provided as a multi-dimensional database that employs online analytical processing (OLAP) or other techniques to generate business-related data from multiple different sources of data. An organization can extract such business-related data from one or more vertical and/or horizontal business applications, and inject the extracted data into a data warehouse instance that is associated with that organization,

Such environments allow customers (tenants) to develop computer-executable software analytic applications for use with a BI component, such as, for example, an Oracle Business Intelligence Applications (OBIA) environment, or other type of BI component adapted to examine large amounts of data sourced either by the customer (tenant) itself, or from multiple third-party entities. As another example, an analytics environment can be used to pre-populate a reporting interface of a data warehouse instance with relevant metadata describing business-related data objects in the context of various business productivity software applications, for example, to include predefined dashboards, key performance indicators (KPIs), or other types of reports.

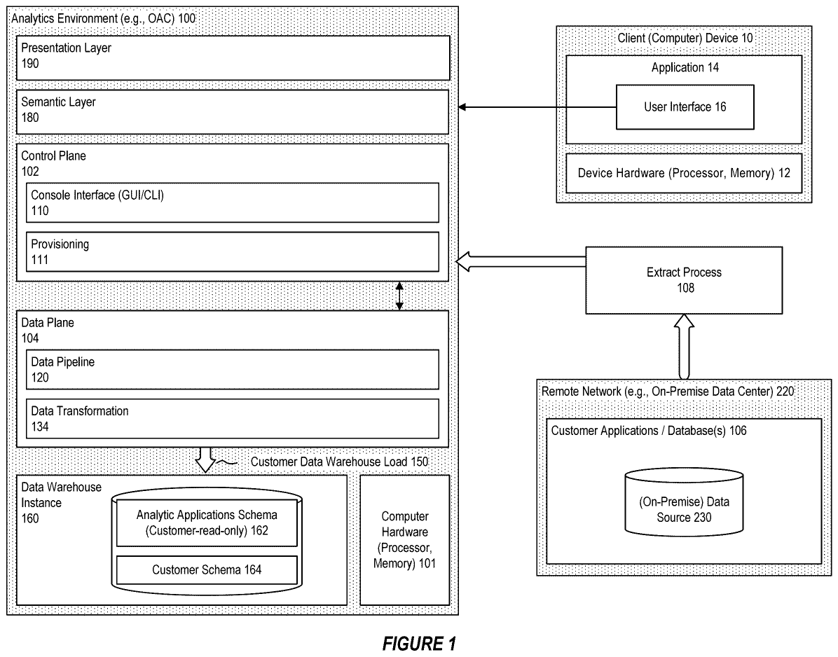

FIG. 1 illustrates an example of an analytics environment, in accordance with an embodiment.

The example shown and described in FIG. 1 is provided for purposes of illustrating an example of one type of data analytics environment that can utilize the various embodiments of remote data gateway as described herein. In accordance with other embodiments and examples, the remote data gateway features that are described herein can be used with other types of data analytics environments.

As illustrated in FIG. 1, in accordance with an embodiment, an analytic applications environment or analytics environment 100 can be provided by, or otherwise operate at, a computer system having a computer hardware (e.g., processor, memory) 101, and including one or more software components operating as a control plane 102, and a data plane 104, and providing access to a data warehouse, or data warehouse instance 160.

In accordance with an embodiment, the components and processes illustrated in FIG. 1, and as further described herein with regard to various other embodiments, can be provided as software or program code executable by a computer system or other type of processing device. For example, in accordance with an embodiment, the components and processes described herein can be provided by a cloud computing system, or other suitably-programmed computer system.

In accordance with an embodiment, the control plane operates to provide control for cloud or other software products offered within the context of a SaaS or cloud environment, such as, for example, an Oracle Analytics Cloud or Oracle Cloud Infrastructure environment, or other type of cloud environment. For example, in accordance with an embodiment, the control plane can include a console interface 110 that enables access by a client computer device 10 having a device hardware 12, application 14, and user interface 16, under control of a customer (tenant) and/or a cloud environment having a provisioning component 111.

In accordance with an embodiment, the console interface can enable access by a customer (tenant) operating a graphical user interface (GUI) and/or a command-line interface (CLI) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request the provisioning of a customer schema 164 within the data warehouse. The customer can also supply, via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer.

In accordance with an embodiment, the provisioning component can also be used to update or edit a data warehouse instance, and/or an ETL process that operates at the data plane, for example, by altering or updating a requested frequency of ETL process runs, for a particular customer (tenant).

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (KM), or other type of data model, that the system uses to transform the transactional data received from business applications and corresponding transactional databases provisioned in the SaaS environment, into a model format understood by the analytics environment. The model format can be provided in any data format suited for storage in a data warehouse. In accordance with an embodiment, the data plane can also include a data and configuration user interface 130, and mapping and configuration database 132.

In accordance with an embodiment, the data warehouse can include a default analytic applications schema (referred to herein in accordance with some embodiments as an analytic warehouse schema) 162 and, for each customer (tenant) of the system, a customer schema as described above.

In accordance with an embodiment, the data plane is responsible for performing extract, transform, and load (ETL) operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the analytic applications schema, which can be updated by a data pipeline or process, for example, an ETL process, on a periodic or other basis.

In accordance with an embodiment, a data pipeline or process can be scheduled to execute at intervals (e.g., hourly/daily/weekly) to extract transactional data from an enterprise software application or data environment, such as, for example, business productivity software applications and corresponding transactional databases 106 that are provisioned in the SaaS environment.

In accordance with an embodiment, an extract process 108 can extract the transactional data, whereupon extraction the data pipeline or process can insert extracted data into a data staging area, which can act as a temporary staging area for the extracted data. The data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

As described above, in accordance with an embodiment, the data pipeline or process can operate in combination with the data transformation layer to transform data into the model format. The mapping and configuration database can store metadata and data mappings that define the data model used by data transformation. The data and configuration user interface (UI) can facilitate access and changes to the mapping and configuration database.

In accordance with an embodiment, the data transformation layer can transform extracted data into a format suitable for loading into a customer schema of data warehouse, for example according to the data model as described above. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications.

In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

### Remote Data Gateway

In accordance with an embodiment, the system can include a remote data gateway (RDG) for use with a data analytics warehouse or other types of analytic application environment, or analytics cloud computing environment, such as, for example, an Oracle Analytics Cloud (OAC) environment. The analytics cloud environment can communicate through a firewall with an on-premise environment that channels database queries between the analytics cloud environment and an on-premise database; including that the analytics cloud environment issues and queues queries; the remote data gateway agent looks for queries to process; executes the queries; and sends the query results to the analytics cloud environment.

In accordance with an embodiment, the remote data gateway enables secure access by a data analytics warehouse operating in a cloud environment, to a customer's on-premise data, without migrating their on-premise data to the cloud. An on-premise data client and remote data gateway server communicate periodically, via a remote data gateway agent, to check for subsequent requests, for example to provide on-premise data to the cloud environment, or to run data analytics on the on-premise data.

The remote data gateway enables an analytics cloud environment to access and use large on-premise data sets, without migrating the data to the cloud. Users can then analyze the data, for example by using a business intelligence (BI) server or data visualization (DV) component in generating data visualizations, or in reporting dashboards and analyses.

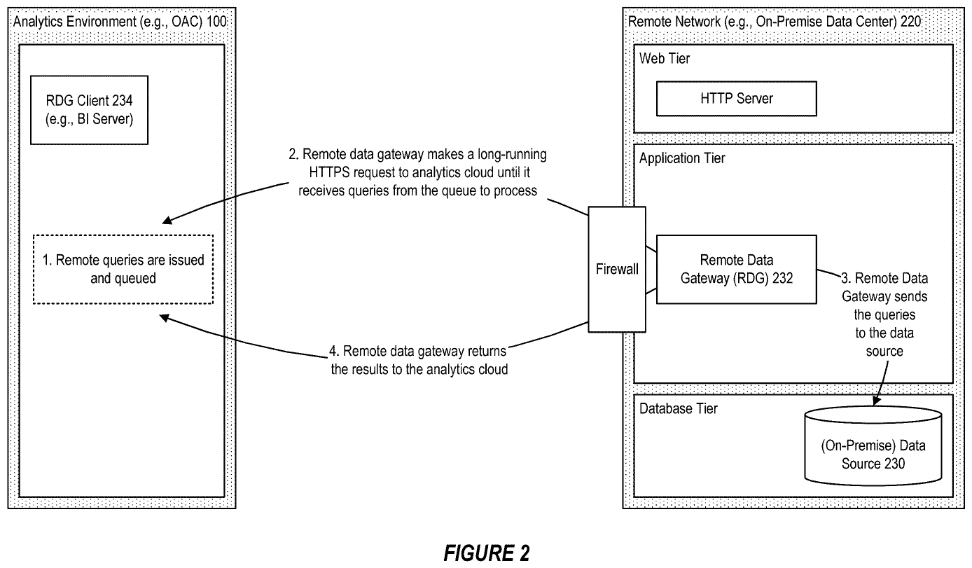

FIG. 2 illustrates the use of a remote data gateway with an analytics environment, in accordance with an embodiment.

As illustrated in FIG. 2, in accordance with an embodiment, in a deployment at a remote network 220 (e.g., a customer on-premise data center) that includes a data source 230, a remote data gateway 232 is installed in the remote network and configured as an agent for communication with a remote data gateway client 234, for example an analytics cloud instance, such as a business intelligence (BI) server (e.g., Oracle BI Server, Oracle BI Publisher), or other entity that requires access to the data.

In accordance with an embodiment, the analytics cloud environment can communicate through a firewall with the on-premise database using HTTPS, while the remote data gateway agent installed in the on-premise environment channels database queries between the analytics cloud environment and the on-premise database.

For example, as further illustrated in FIG. 2, the analytics cloud environment issues and queues queries; the remote data gateway operating as an agent looks for queries to process; executes the queries; and sends the query results to the analytics cloud environment.

In accordance with an embodiment, the remote data gateway polls the analytics cloud environment for queries to run against the on-premise data sources, and the results of these queries are returned to the analytics cloud environment.

In accordance with an embodiment, remote data gateway traffic can be signed with an encryption key, and each packet additionally encrypted by Transport Layer Security/Secure Sockets Layer. Data flows can source data from remote connections; however, data flows generally cannot save data to data sets that use remote connections.

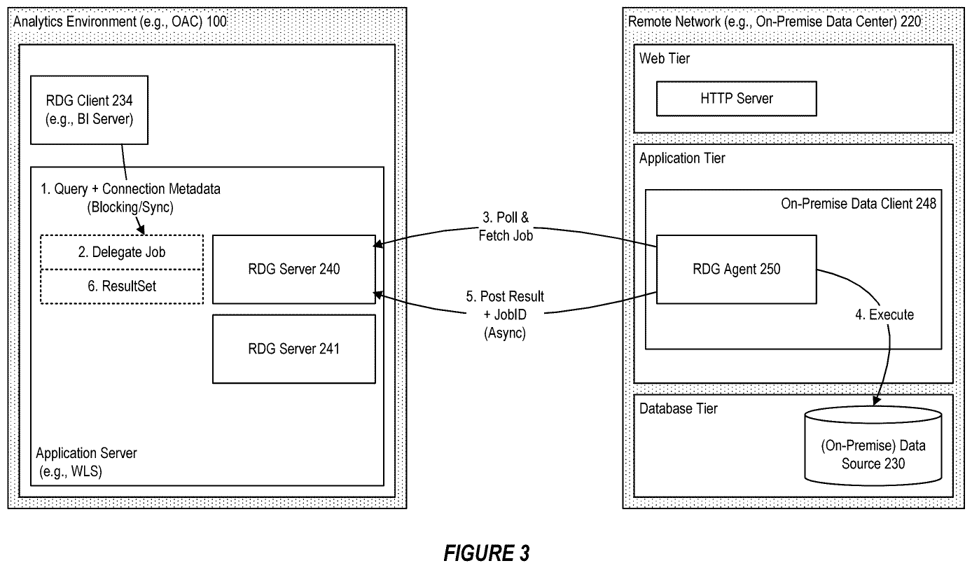

FIG. 3 further illustrates the use of a remote data gateway with an analytics environment, in accordance with an embodiment.

As illustrated in FIG. 3, in accordance with an embodiment, a remote data gateway server (RDG server) 240 (or in the case of multiple remote data gateway servers, either of RDG servers 240, 241) can communicate with a remote data gateway agent (RDG agent) 250 deployed behind a customer firewall on the network of their data store. An on-premise data client 248 and remote data gateway server communicate periodically, via a remote data gateway agent, to check for subsequent requests, for example to provide on-premise data to the cloud environment, or to run data analytics on the on-premise data.

In accordance with an embodiment, the remote data gateway agent connects to the analytics cloud environment, and asks for pending jobs. At the analytics cloud environment, a remote data gateway server assigns a pending job, from a queue of pending jobs maintained by the server. The remote data gateway agent can connect to the on-premise database, and execute, for example, a SQL query provided by the job (asynchronously).

In accordance with an embodiment, the remote data gateway agent then posts the result set for the job to the analytics cloud environment (remote data gateway server). The analytics cloud environment consumes the query results, and renders visualizations, reports, or dashboards as appropriate.

In accordance with an embodiment, the remote data gateway environment comprises the remote data gateway server and the remote data gateway agent. Both components can be provided, for example, as J2EE web applications (WebApps) designed to be deployed on an application server environment, such as for example, a WebLogic (WLS) or other type of application server.

In accordance with an embodiment, the remote data gateway server acts as a proxy and a buffer for the queries from a remote data gateway client, e.g., a business intelligence (BI) server, such as for example an Oracle BI Server, which operates to hide the asynchronous and stateful communication (e.g., RDCv2) protocol, from the synchronous and stateless BI server.

In accordance with an embodiment, the remote data gateway client or BI server propagates additional connection metadata, for example, to a Java data structure (DS) environment or RDataHandler. The RDataHandler wraps the query in an RDataJob wrapper class that is inserted into the RDataQueue, which serves as the source of jobs for remote data gateway agents. The remote data gateway server maintains the state of the jobs, and persists the history of completed or failed jobs in the, e.g., BI server platform database, for archival and analytics.

In accordance with an embodiment, the remote data gateway agent can be provided as a version of an obi-datasrc-server web application that include Java DS Server and JDBC Cartridge connectivity, packaged as a obi-remotedataconnector.war file. The remote data gateway agent can include a pool of threads for polling the remote data gateway server, and another pool of threads for executing jobs. This allows the poller thread pool to be free to check for pending jobs on the remote data gateway server in parallel, while the executor thread pool can continue executing existing assigned jobs and posting their results back to the remote data gateway server.

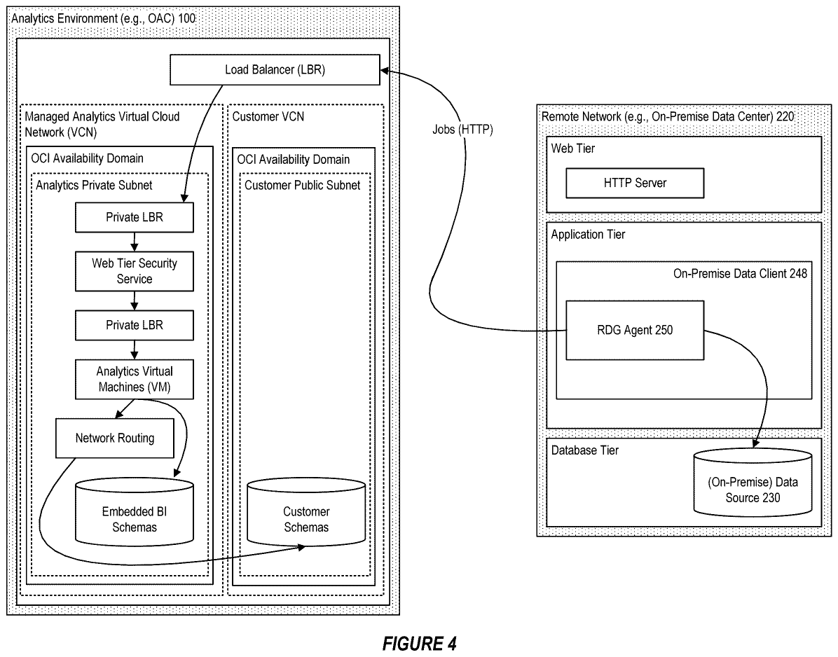

FIG. 4 further illustrates the use of a remote data gateway with an analytics environment, in accordance with an embodiment.

As illustrated in FIG. 4, in accordance with an embodiment, an analytics environment provided, for example, as Oracle Analytics Cloud (OAC), can be provided as a combination of individual BI servers and managed server instances that execute on virtual machines (VMs), wherein a load balancer directs inbound requests to the virtual machines in a round-robin fashion. For a remote data gateway agent, this implies two requirements:
A means of connecting to all virtual machines in the, e.g., OAC, deployment to pick up jobs from all of them; and
A means of posting results back to the same virtual machine that the job was picked up from (since communication of BI server with a remote data gateway server is synchronous, the BI server is waiting for the result to be provided by the same remote data gateway server).

In accordance with an embodiment, to address this, the system can employ load balancer stickiness or session persistence, for example using cookies. Fetching jobs can be performed without cookies in the HTTP requests, so the load balancer freely directs the fetch request to any managed server. Sufficiently frequent (e.g., two requests per second) fetch requests from the remote data gateway agent ensure that all managed servers are polled for jobs.

In accordance with an embodiment, using for example HTTP 1.0 (job polling): a client remote data gateway agent initiates a GET request on a job queue HTTP end point after authentication. The job queue is populated on the remote data gateway server side with query payloads generated, for example, from interactive analysis. The client uses the job object to execute the query payload remotely. Once the job is complete, the client initiates a POST to the same endpoint with origin server cookie to ensure posting with origin server affinity.

In accordance with an embodiment, using for example web-sockets: the client and server establish a long running full duplex communication. The client keeps listening for server requests. The remote data gateway server pushes the job objects to the client and client will complete processing and post results to the server.

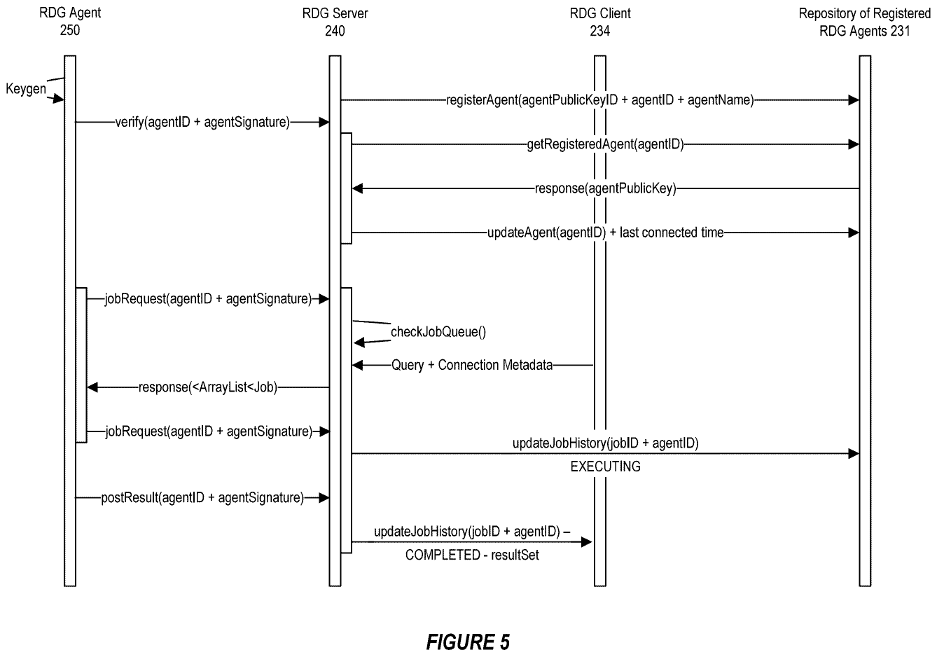

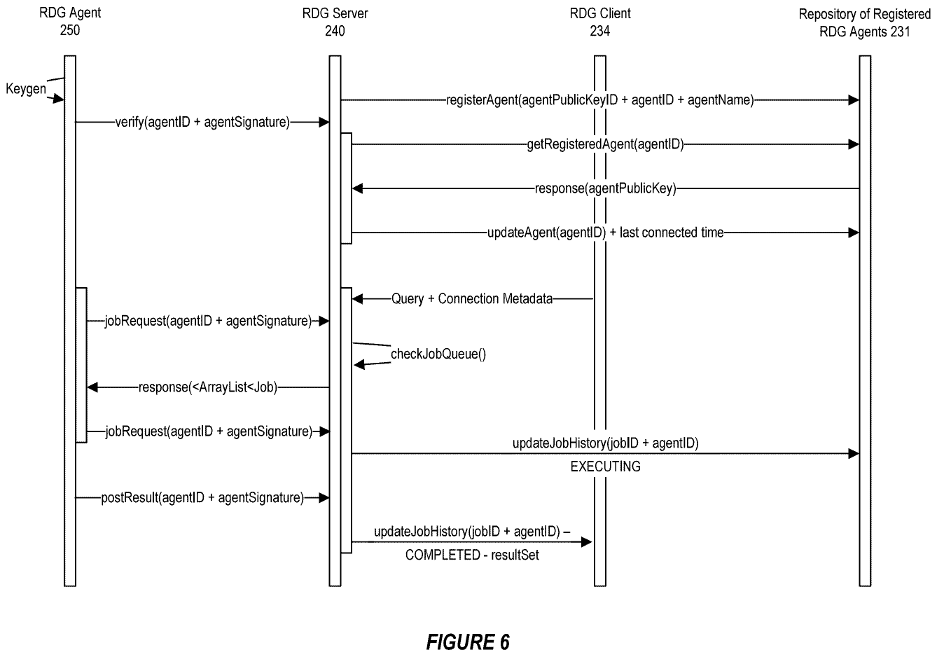

FIGS. 5-6 illustrate example sequence diagrams associated with the use of a remote data gateway with an analytics environment, in accordance with an embodiment.

As illustrated in FIGS. 5-6, in accordance with various embodiments, an on-premise data client and remote data gateway server communicate periodically, via a repository of registered RDG agents 231, to check for subsequent requests, for example to provide data from an on-premise data source, to the cloud environment, or to run data analytics on the on-premise data.

In accordance with various embodiments, either the remote data gateway agent can call into the client prior to the client issuing a request (FIG. 5); and/or the client can issue a request prior to the remote data gateway agent checking for the request (FIG. 6).

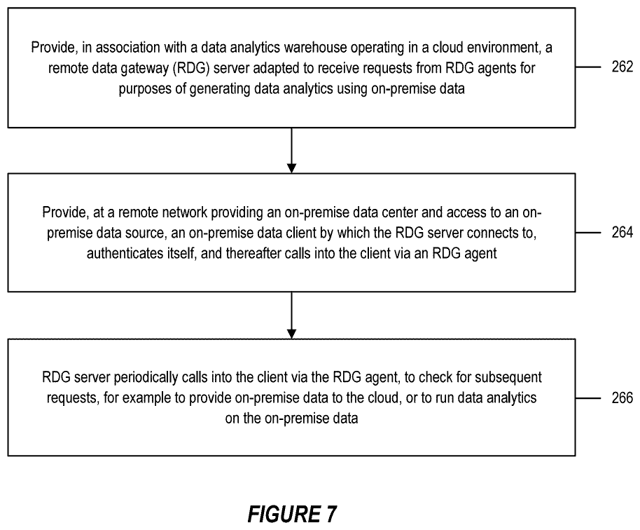

FIG. 7 illustrates a process for use of a remote data gateway with an analytics environment, in accordance with an embodiment.

As illustrated in FIG. 7, in accordance with an embodiment, at step 262, in association with a data analytics warehouse operating in a cloud environment, a remote data gateway (RDG) server is adapted to receive requests from remote data gateway agents for purposes of generating data analytics using on-premise data.

At step 264, at a remote network providing an on-premise data center and access to an on-premise data source, an on-premise data client is provided by which the remote data gateway server connects to, authenticates itself, and thereafter calls into the client via a remote data gateway agent.

At step 266, the remote data gateway server periodically calls into the client via the Remote data gateway agent, to check for subsequent requests, for example to provide on-premise data to the cloud environment, or to run data analytics on the on-premise data.

### Tracking Multi-Tenant Starvation

In accordance with an embodiment, the remote data gateway server maintains a timestamp for when the remote data gateway agent was last seen—to identify if the remote data gateway server is starving. For example, if an agent has not connected in the last 20 seconds, then the remote data gateway server assumes it is starving. In such an event, any new jobs that arrive, are immediately routed to the shared queue in the database. Each job does not wait to starve before being routed.

In accordance with an embodiment, in a multi-tenant environment, this timestamp is specific to a tenancy. This means remote data gateway agents for another tenant/customer could be connected to the remote data gateway server, but the remote data gateway server could still be starving for agents of a particular tenant.

Additionally, in accordance with an embodiment, if a tenant has multiple agents configured, then any one of them can pick up the jobs for execution. Not all agents of a tenant need to be connected simultaneously. A server can maintain a starvation map by tenancy—based on the remote data gateway agents that are connecting and requesting for jobs.

### Remote Data Gateway Protocol in a Multi-Tenant Environment

As described above, increasingly, there is an interest in developing software applications that leverage the use of data analytics within the context of an organization's enterprise software application or data environment, such as, for example, an Oracle Fusion Applications environment or other type of enterprise software application or data environment; or within the context of a software-as-a-service (SaaS) or cloud environment, such as, for example, an Oracle Analytics Cloud or Oracle Cloud Infrastructure environment, or other type of cloud environment.

Current versions of Oracle Analytics Cloud (OAC) employ a large number of single-tenant monolithic instances. In such environments, the components may be scaled even if little/not used by the customer. Complex upgrades must be run on each instance separately; and overall, it can be costly to maintain/enhance autonomy, density, elastic scaling, and resilient ZDT upgrades.

Increasingly, such environments are intended to support multiple tenants or customers. In such environments, services may be designed to be stateless, i.e., to provide a separation of functionality versus data. This allows a single/same service to support multiple tenants/customers, at the same time, and with appropriate secure data separation.

In accordance with an embodiment, a remote data gateway (RDG) server, for example an Oracle Data Gateway instance, enables secure access by the data analytics environment to a customer's on-premise data, without migrating the on-premise data to the cloud. The RDG server can expose a port, which an RDG agent connects to for job requests, for example to provide on-premise data to the cloud environment, or to run data analytics on the on-premise data.

Such an RDG protocol generally operates as an asynchronous protocol, in that the RDG agent executes jobs as part of processing a request, and submits a response or results through an out-of-band asynchronous connection to the same RDG server. In such environment, the system needs to ensure that a response goes back to where the request was originally picked up; and that an RDG agent can only pick up jobs for tenants/customers associated with the agent.

However, while some RDG implementations address this by using a common job store, this can result in reduced performance or inefficiency. In other RDG implementations, although peer-to-peer routing can be used to improve performance for a single tenant/customer, such an approach is typically not as efficient when supporting multiple tenants/customers.

In accordance with an embodiment, described herein are systems and methods for providing a remote data gateway protocol in a multi-tenant environment, for use with data analytics warehouses or other computing environments.

In accordance with an embodiment, the remote data gateway enables secure access by a data analytics warehouse, operating in a cloud environment, to a customer's data. The system supports routing of requests and achieves comprehensive connectivity in multi-tenant environments, through tenancy-binding using a combination of consistent-hashing and cluster subsets in the load balancer.

In accordance with an embodiment that includes a Kubernetes microservices environment, the use of a consistent-hashing scheme, in combination with specific keys in the header to determine which subset of pods to connect to, can be used to maintain, for the duration of processing several requests from multiple tenants, a connection to each of one or more microservice pods simultaneously.

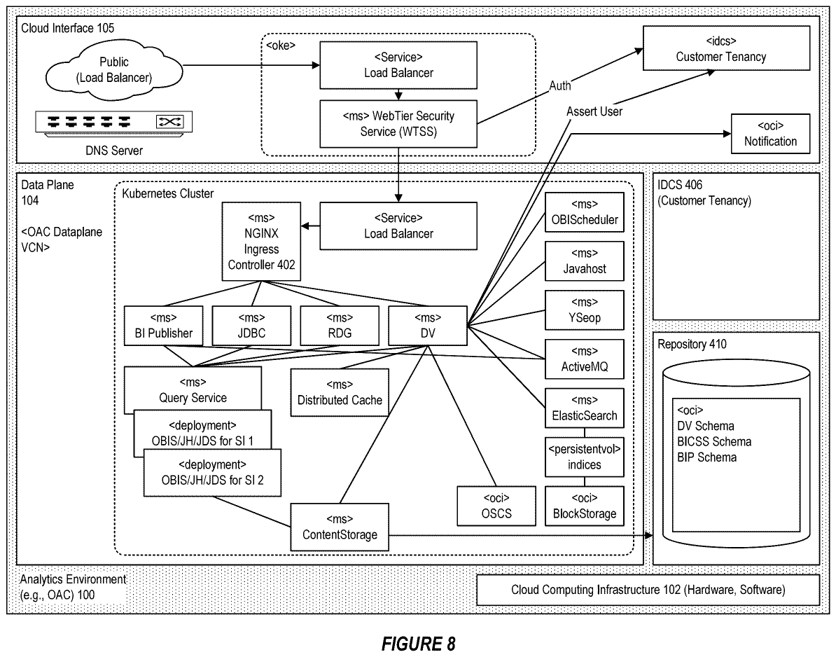

FIG. 8 illustrates an example data analytics environment (e.g., an OAC cluster), in accordance with an embodiment.

In accordance with an embodiment, cloud-based data analytics environments, such those illustrated by way of example in FIG. 8, are intended to support multiple tenants or customers. In such environments, services may be designed to be stateless, i.e., to provide a separation of functionality versus data. When invoked by a tenant/customer as part of a request, a service can access a data repository by stripe, to run with the customer's data. In this manner, services can span multiple threads that allow tenants/customers to access their own data. This allows a single/same service to support multiple tenants/customers, at the same time, and with appropriate secure data separation. The system can also scale-up or scale-down the provisioning of services easily, to reflect a customer's individual needs.

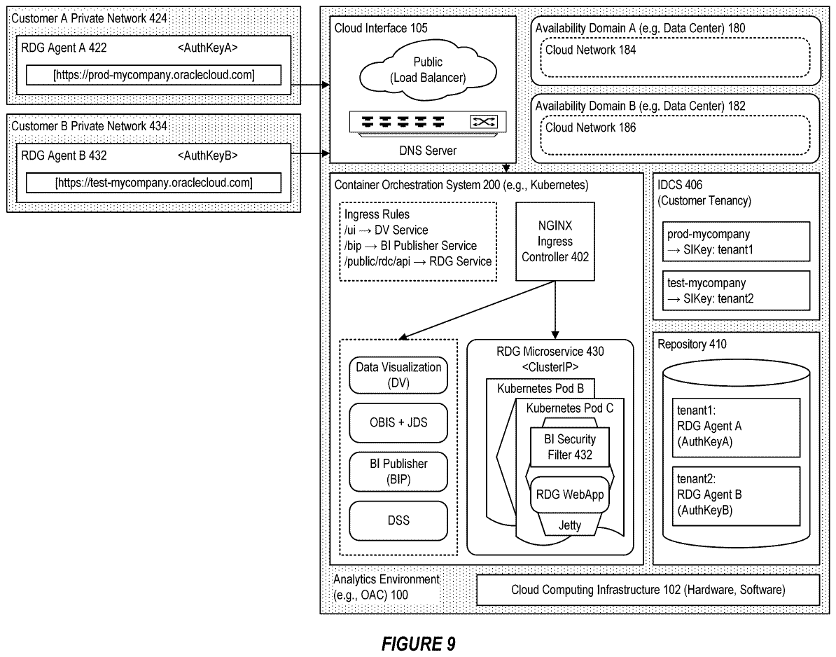

FIGS. 9-11 illustrate providing a remote data gateway protocol in a multi-tenant environment for use with a data analytics warehouse, in accordance with an embodiment.

As illustrated in FIG. 9, in accordance with an embodiment, a data analytics environment 100 can operate on a cloud computing infrastructure 102 comprising hardware (e.g., processor, memory), software resources, and one or more cloud interfaces 105 or other application program interfaces (API) that provide access to the shared cloud resources via one or more load balancers 106.

In accordance with an embodiment, the environment supports the use of availability domains A 180, B 182, which enables tenants/customers to create and access cloud networks 184, 186, and run cloud instances. A tenancy can be created for each cloud tenant/customer, for example Customer A 424, B 434, which allows the tenant/customer to access each of their cloud instances.

As described above, in accordance with an embodiment, the remote data gateway protocol operate as an asynchronous protocol, in that a remote data gateway agent executes jobs as part of processing a request, and submits a response or results through an out-of-band asynchronous connection to the same remote data gateway server.

Generally described, jobs for execution are submitted to an RDG server; an RDG agent picks up the jobs for execution, and then posts the results back to the calling application. This approach means that the system needs to ensure that a response goes back to where the request was originally picked up; and that an RDG agent can only pick up jobs for those tenants/customers associated with the agent.

However, the use of a common job store, as illustrated in some of the examples above, can result in computer inefficiency. Additionally, while the above-described approach of RDG peer-to-peer routing works well for a single tenant/customer, it is typically not as efficient when supporting multiple tenants/customers.

In accordance with an embodiment, data analytics requests can be associated with various services, such as for example, an Oracle Business Intelligence Service (OBIS), Java Data Source (JDS), BIP Publisher (BPS), Dataset Service (DSS), or Data Visualization (DV).

In accordance with an embodiment, such services can operate as a client of an RDG server, to receive and process requests from end users/clients in accessing their data source, for purposes of generating data analytics or other use cases.

In accordance with an embodiment, a remote data gateway (RDG) can be provided within a Kubernetes cluster 200, as an RDG microservice 430—distinct from, for example, an OBIS/JDS service. The described approach includes moving the RDG server functionality into a Web app of its own—removing dependencies and common components shared with other services. A docker image for the RDG server with HELM charts (YAML) allow sit to be consumed and instantiated as part of the Kubernetes cluster of the OAC stack.

In accordance with an embodiment, the RDG agent initiates an inbound connection to the data analytics environment (e.g., OAC) to pick up query jobs and post results. To achieve connectivity to all scaled out HA nodes, the agent uses multiple polling threads to keep long-poll HTTP connections on retainer.

In accordance with an embodiment, multi-tenant deployment across multiple Pods in a SE/Kubernetes deployment requires comprehensive connectivity from each agent to all server Instances which can grow/reduce in number dynamically.

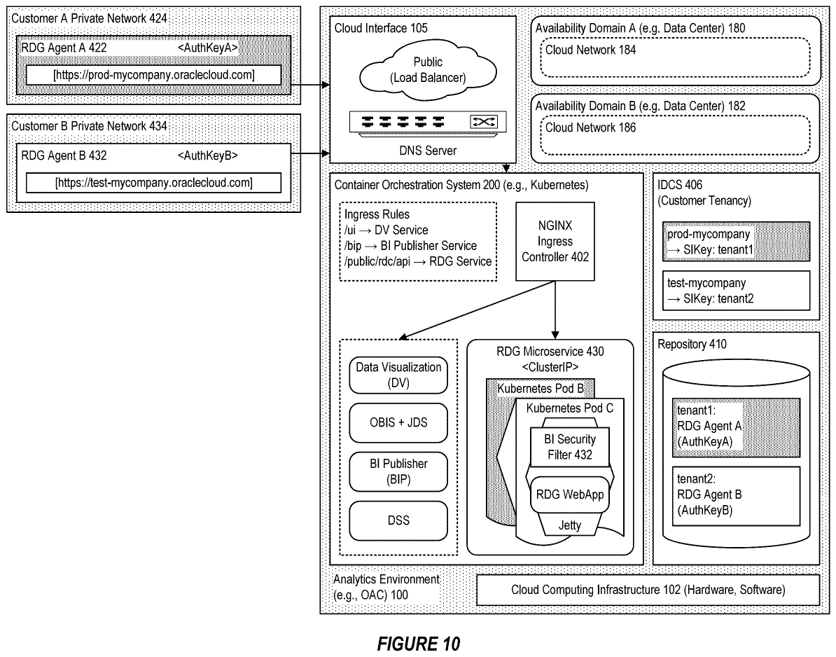

For example, as illustrated in FIGS. 10-12, each of the RDG Agent A 422, RDG Agent B 432 operate to access a repository 410, on behalf of various tenants/customers, through the same load balancer environment. Each of the different tenants/customers can access the systems via requests directed to a different URL endpoint (here, for example [https://prod-mycompany.oraclecloud.com] and [https://test-mycompany.oraclecloud.com]).

In accordance with an embodiment, an RDG agent attempts a connection to an RDG microservice, which authenticates the incoming request (for example using an identity service 406, e.g., an Oracle Identity Cloud Service (IDCS), and translates the request URL into a tenant identifier or key (generally referred to herein as an SI Key or SIKey, e.g., tenant 1, tenant2).

For example, in this manner, each of RDG Agent A and RDG Agent B would hit different public endpoints, thereby allowing them to be routed with the correct SIKey (TenantID) information injected into the request. The RDG agents themselves do not explicitly know which SIKey or TenantID they are servicing—only that they have different URLs.

Coupled with the use of agent registration authentical keys (Auth Keys), the described approach operates to prevents one RDG agent from trying to impersonate another RDG Agent.

By way of example, in accordance with an embodiment illustrated in FIG. 10, in this example, RDG Agent A has a first endpoint, which the identity service indicates is associated

with SIKey tenant1, and which can then be used to access the data repository by stripe associated with that tenant.

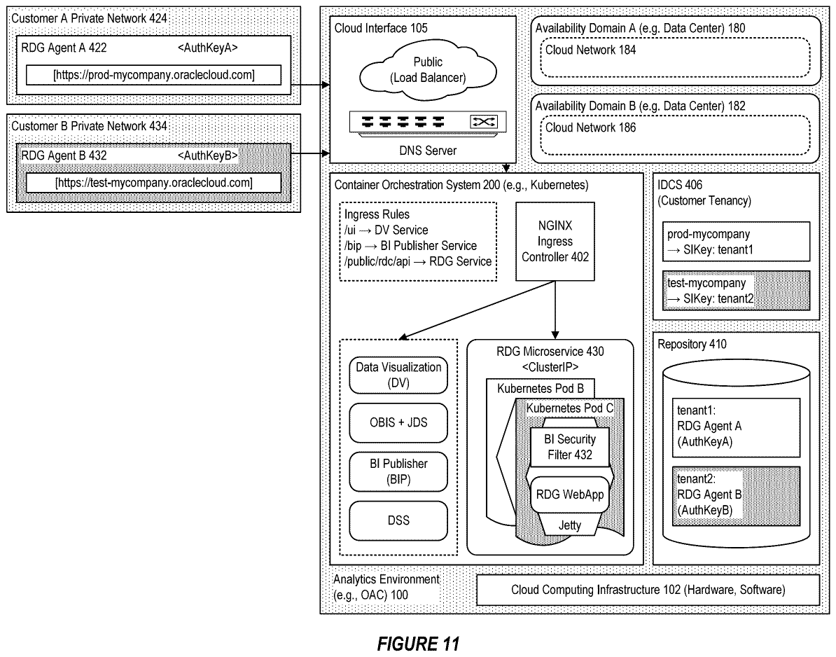

Similarly, in accordance with an embodiment illustrated in FIG. 11, in this example, RDG Agent B has a second endpoint, which the identity service indicates is associated with SIKey tenant2, and which can then be used to access the data repository by stripe associated with that tenant.

So, in the example illustrated above, RDG Agent A will hit the endpoint:
https://prodmycompany.oracleanalytics.com/public/rdc/api/v1/query

While, in this example, RDG Agent B will hit the endpoint:
https://testmycompany.oracleanalytics.com/public/rdc/api/v1/query

Both of which will reach the same Kubernetes cluster to be serviced—with an injected header SIKey=tenant1/tenant2 as appropriate as part of their request header when the request reaches the RDG microservice for routing to Pod B or Pod C, which together with an RDG private load balancer make up the RDG microservice.

In accordance with an embodiment, to meet the requirements of the RDG protocol, each of RDG Agent A and RDG Agent B need to operate via a same Kubernetes pod, to process a particular request. When invoked by a tenant/customer as part of a request, the RDG microservice can the access a data repository by stripe, to run with the customer's data. A BI security filter in each pod is used to ensure that the job process is secure, for example by validating the SIKey for each job.

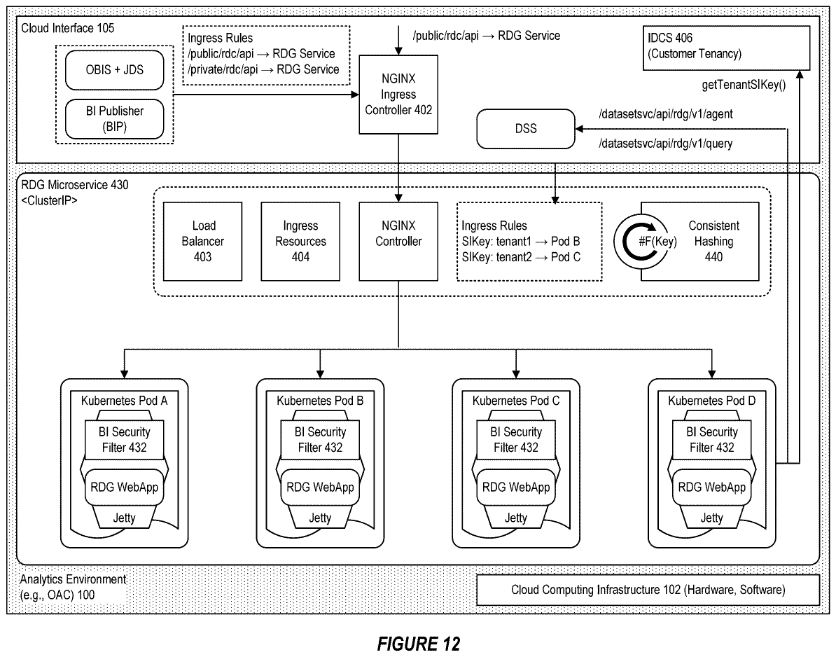

FIG. 12 further illustrates providing a remote data gateway protocol in a multi-tenant environment, in accordance with an embodiment.

As illustrated in FIG. 12, in accordance with an embodiment, the RDG microservice can include an Nginx access controller 402, an Nginx Plus load balancer 403, and ingress resources 404; and can operating a consistent-hashing process 440 as described below to distribute RDG requests among the various pods.

In accordance with an embodiment, the consistent-hashing scheme ensures that requests and responses associated with particular tenants are handled by the same pod.

Generally described, each collection of RDG microservice pods can be distributed among the multiple tenants/customers—so for example, a first subset of pods or a Pod A can be associated with requests from a first set of Tenants, 1, 3, 5; while a second subset of pods or a Pod B can be servicing or associated with requests from a second set of Tenants 2, 4, 6.

In accordance with an embodiment, the consistent-hashing scheme can be used in combination with a specific key in the header (e.g., the SIKey) to determine which subset of pods to connect to. In this manner, the system can effectively maintain, for the duration of processing several requests from multiple tenants, a connection to each of the RDG microservice pods simultaneously—providing comprehensive connectivity in a multi-tenant environment.

In accordance with an embodiment, a scaling-out factor can be used to determine an initial amount of pods required for a particular tenant/customer, or to increase the amount of pods as appropriate.

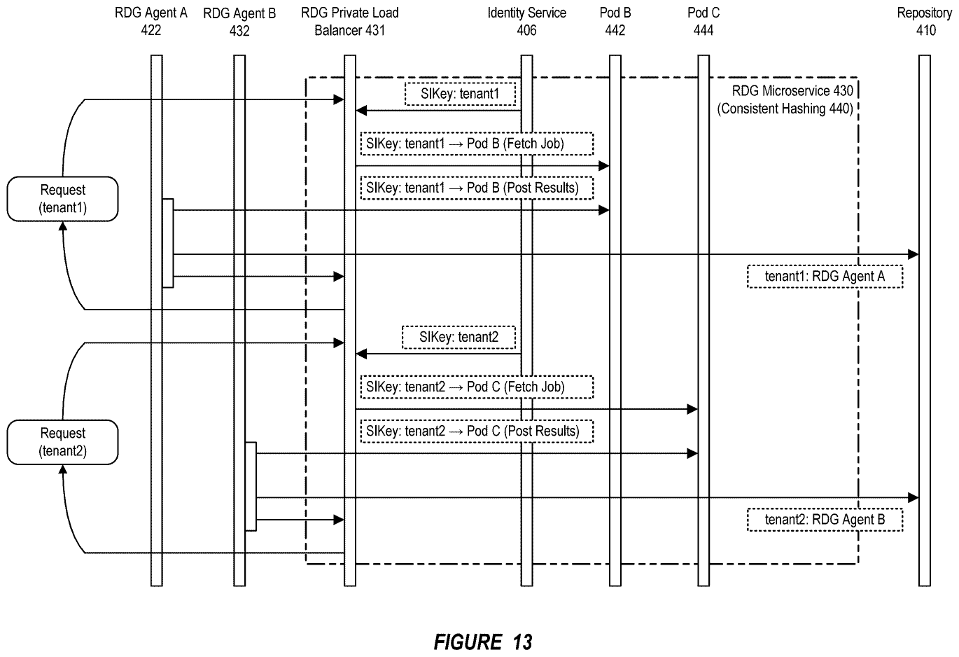

FIGS. 13-15 illustrate example sequence diagrams associated with providing a remote data gateway protocol in a multi-tenant environment, in accordance with an embodiment.

As illustrated in FIG. 13, in accordance with an embodiment, a request originates at a client (e.g., OBIS or BIP) and is directed for processing by the RDG microservice. The RDG protocol operates to tie an agent of a particular tenant, with the querying of the database by the agent/server; and to tie an original request, with an eventual response.

In accordance with an embodiment, an RDG agent generally makes two calls to a pod—a first call to fetch a job, and then a second call to post the results for that job—to the same pod where that job was picked up.

Since multiple pods could be servicing a single tenant, in accordance with an embodiment to achieve high availability, the system can incorporate the use of load balancer stickiness, or session persistence using cookies, to help determine which pod to send the results.

By way of example, in accordance with an embodiment, if an RDG microservice cluster includes three pods (Pod A, Pod B, Pod C) with a high-availability scale factor of two pods for each RDG agent, then the cluster distribution may operate similar to:

$$\begin{matrix}SlKey 1 = tenant 1 = Requests from ( Pod A + Pod B ) \\ SlKey 2 = tenant 2 = Requests from ( Pod B + Pod C ) \\ SlKey 3 = tenant 3 = Requests from ( Pod A + Pod C )\end{matrix}$$

In this example, the results of jobs that are fetched from Pod C (for tenant3) need to go to Pod C—even though Pod A is also servicing tenant 3.

Using load balancer stickiness, or session persistence using cookies, this can be achieved by routing the result using not just the SIKey, but also the cookie returned with the job.

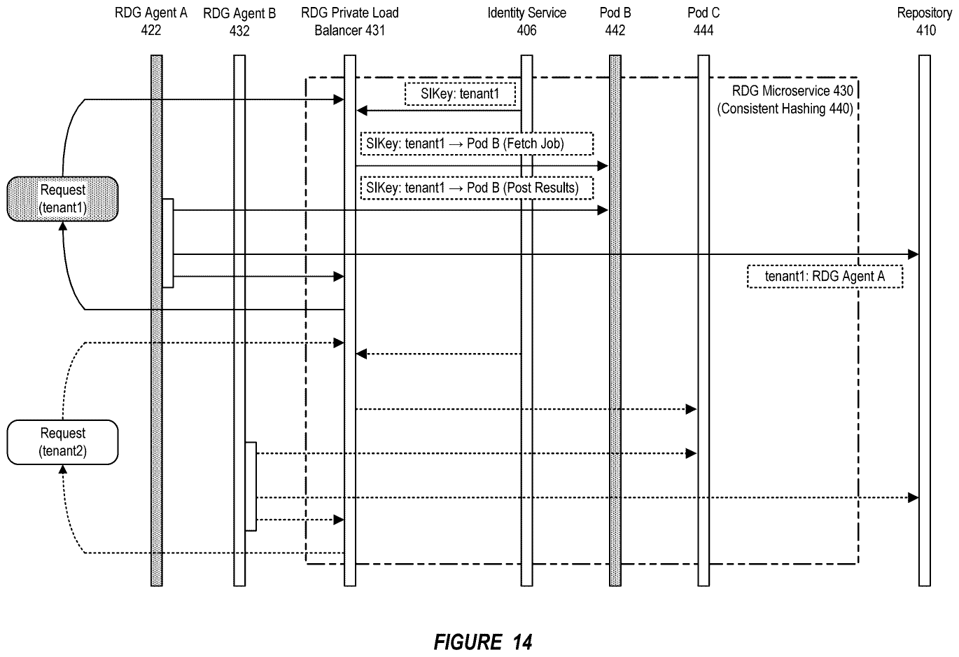

For example, as illustrated in FIG. 14, when the request arrives at the RDG microservice, via an RDG private load balancer 431 which routes RDG requests by SIKey/TenantID, the microservice may determine that the original request is for a Tenant 1 (tenant1) and Pod B (442). The RDG agent for Tenant 1 contacts the RDG microservice, and the ingress controller determines that this (second) request should go to Pod B also. This second request is understood as the RDG agent asking if there are any jobs pending for Tenant 1. The RDG agent gets the jobs, accesses the database on behalf of that tenant, and then goes back to the RDG microservice and indicates it has a response for Tenant 1 (tenant1) at Pod B.

In accordance with an embodiment, during this time, the original request from the client (e.g., OBIS or BIP) is still awaiting a response. Eventually the RDG microservice returns a response to the original request, to the original client.

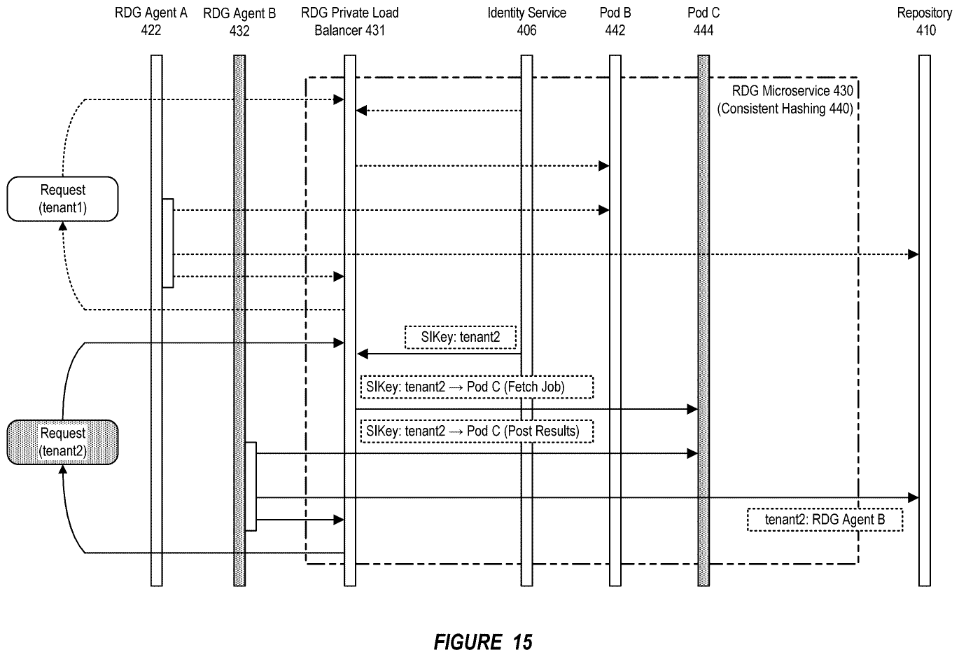

Similarly, as illustrated in FIG. 15, if the RDG microservice determines that the original request is for Tenant 2 (tenant2) and Pod C (444), then the RDG agent for Tenant 2 contacts the RDG microservice, and the ingress controller determines that this (second) request should go to Pod C also—wherein that RDG agent gets the jobs, accesses the database on behalf of that tenant, and then goes back to the RDG microservice and indicates it has a response for Tenant 2 (tenant2) at Pod C.

As described above, in accordance with an embodiment, the tying of the agent of a particular Tenant 1 (tenant1), and the querying of the database by the agent/server, is provided by the RDG protocol. Similarly, the tying of the original request, and the eventual response, to response, is also provided by the RDG protocol.

### Additional Features

In accordance with an embodiment, the system can include the use of, for example:

A split tenant-specific load using an Nginx Plus load balancer and ingress controller.

In-bound connections from internal clients (OBIS/BIP) to provide a Tenant ID for proper routing of queries to the right pod for delegation to a tenant-specific agent.

In-bound connections from external clients (RDG Agent)—compute Tenant ID/SIKey using IDCS plus a BI Security Filter.

The use of consistent-hashing to share load across pods in an RDG microservice cluster with dynamic number of pods.
nginx.ingress.kubernetes.io/upstream-hash-by: “$request_uri$host

In accordance with an embodiment, the system can provide high availability by sharing load of each tenant across 2 pods, using subset hashing.
nginx.ingress.kubernetes.io/upstream-hash-by-subset: “true”

In accordance with an embodiment, upstream-hash-by-subset-size determines the size of each subset. The system can provide an Nginx Plus load balancer to be configured for session affinity/stickiness using JSESSIONID Cookie in a HA deployment.

### Load Balancing Scaled-Out OAC Instances—Alternate Approaches

In accordance with an embodiment, alternative approaches can include, for example:

The use of peer routing in RDG—peer routing/remote routing of RDG jobs and results using a job table plus peer-server-as-a-proxy.

The use of a broadcast agent connection request to all pods.

Support for hand-off/delegate connection requests using multicast co-operation between pods.

### Retrieve/Compute Tenant ID

In accordance with an embodiment, the system can provide configuration settings and environment variables to BI Security Filter to compute SIKey/Tenant ID when a connection request is received; default: bootstrap.

In accordance with an embodiment, the system can use a BISecurityFilter to compute the Tenant SIKey—authentication/authorization is handled by the RDG server using the agent registration (Agent ID plus Agent Auth Key).

### Security and Lifecycle Management (Resilience)

In accordance with an embodiment, the SIKey is required for using it as a Stripe ID/Partition Key in the RCU Repository—handled by DSS PlugIn REST APIs. This HTTP HEADER for SIKey/Tenant ID needs to be part of the request before it reaches the pod—because the upstream hashing depends on this header value as a key.

### Cluster Scaling and Re-Hashing With Jobs In-Flight

In accordance with an embodiment, if the Nginx Plus ingress controller rules change, any queries in-flight (waiting for agent, waiting for results, etc.) might be lost due to the asynchronous nature of the RDG protocol.

### Example Use of BI Filters

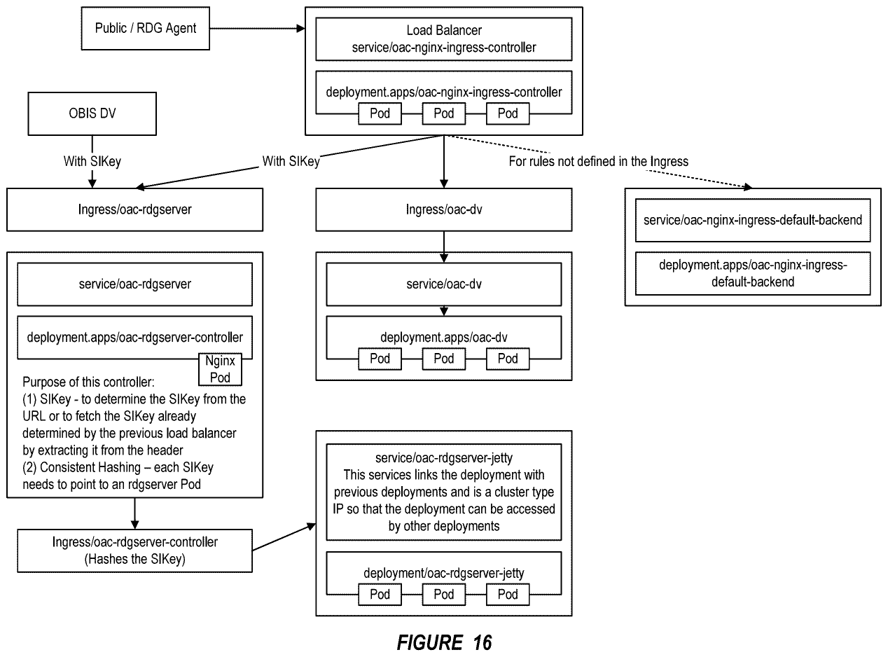

FIG. 16 illustrates the use of an additional BI filter in providing a remote data gateway protocol in a multi-tenant environment, in accordance with an embodiment.

As illustrated in FIG. 16, in accordance with an embodiment, an additional BI filter (distinct from the BI security filter referenced above) can be used, for example, to determine an SIKey from a URL or to fetch the SIKey already determined by a previous load balancer by extracting it from the header; wherein each SIKey needs to point to an RDG server (rdgserver) pod.

### Example Process

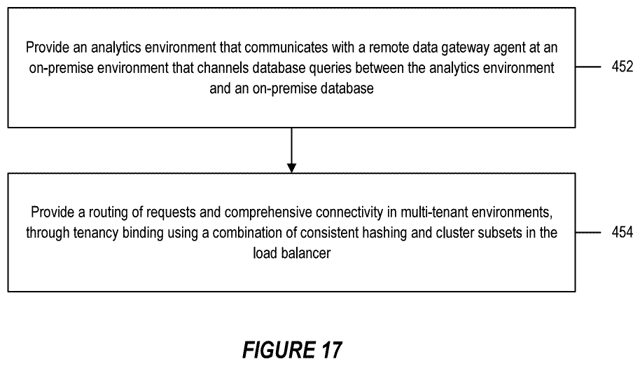

FIG. 17 illustrates a process for providing a remote data gateway protocol in a multi-tenant environment, in accordance with an embodiment.

As illustrated in FIG. 17, in accordance with an embodiment, at step 452, the method includes providing an analytics environment that communicates with a remote data gateway agent at an on-premise environment that channels database queries between the analytics environment and an on-premise database.

At step 454, the method includes providing a routing of requests and comprehensive connectivity in multi-tenant environments, through tenancy-binding using a combination of consistent-hashing and cluster subsets in the load balancer.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

For example, although several of the examples provided herein illustrate operation within the context of, for example, an Oracle Analytics Cloud or Oracle Cloud Infrastructure environment; in accordance with various embodiments, the systems and methods described herein can be used with other types of enterprise software application or data environments, cloud environments, cloud services, cloud computing, or other computing environments.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for providing a remote data gateway that includes routing of requests and comprehensive connectivity in multi-tenant environments, comprising:
a computer including one or more processors, that provides access by an analytics environment to a data warehouse for storage of data; and
wherein the system providing a routing of requests and comprehensive connectivity in multi-tenant environments, through tenancy-binding using a combination of consistent-hashing and cluster subsets in the load balancer.

2. The system of claim 1, wherein the remote data gateway protocol operate as an asynchronous protocol, in that a remote data gateway agent executes jobs as part of processing a request, and submits a response or results through an out-of-band asynchronous connection to the same remote data gateway server.

3. The system of claim 1, wherein a remote data gateway (RDG) is provided within a Kubernetes cluster as an RDG microservice, and wherein each collection of RDG microservice pods can be distributed among the multiple tenants/customers including a first subset of pods associated with requests from a first set of tenants, and a second subset of pods associated with requests from a second set of tenants.

4. The system of claim 1, wherein the tying of an RDG agent of a particular tenant, and the querying of the database by the agent/server; and the tying of the original request, and eventual response, is provided by the RDG protocol.

5. The system of claim 1, wherein a consistent-hashing scheme can be used in combination with a specific key in the header to determine which subset of pods to connect to; and to maintain, for the duration of processing several requests from multiple tenants, a connection to each of the RDG microservice pods simultaneously.

6. A method for providing a remote data gateway that includes routing of requests and comprehensive connectivity in multi-tenant environments, comprising:
providing, at a computer system including one or more processors, access by an analytics environment to a data warehouse for storage of data; and
wherein the system providing a routing of requests and comprehensive connectivity in multi-tenant environments, through tenancy-binding using a combination of consistent-hashing and cluster subsets in the load balancer.

7. The method of claim 6, wherein the remote data gateway protocol operate as an asynchronous protocol, in that a remote data gateway agent executes jobs as part of processing a request, and submits a response or results through an out-of-band asynchronous connection to the same remote data gateway server.

8. The method of claim 6, wherein a remote data gateway (RDG) is provided within a Kubernetes cluster as an RDG microservice, and wherein each collection of RDG microservice pods can be distributed among the multiple tenants/customers including a first subset of pods associated with requests from a first set of tenants, and a second subset of pods associated with requests from a second set of tenants.

9. The method of claim 6, wherein the tying of an RDG agent of a particular tenant, and the querying of the database by the agent/server; and the tying of the original request, and eventual response, is provided by the RDG protocol.

10. The method of claim 6, wherein a consistent-hashing scheme can be used in combination with a specific key in the header to determine which subset of pods to connect to; and to maintain, for the duration of processing several requests from multiple tenants, a connection to each of the RDG microservice pods simultaneously.

11. A non-transitory computer readable storage medium, having instructions stored therein which when read and executed cause a computer to perform a method comprising:
providing, at a computer system including one or more processors, access by an analytics environment to a data warehouse for storage of data; and
wherein the system providing a routing of requests and comprehensive connectivity in multi-tenant environments, through tenancy-binding using a combination of consistent-hashing and cluster subsets in the load balancer.

12. The non-transitory computer readable storage medium of claim 11, wherein the remote data gateway protocol operate as an asynchronous protocol, in that a remote data gateway agent executes jobs as part of processing a request, and submits a response or results through an out-of-band asynchronous connection to the same remote data gateway server.

13. The non-transitory computer readable storage medium of claim 11, wherein a remote data gateway (RDG) is provided within a Kubernetes cluster as an RDG microservice, and wherein each collection of RDG microservice pods can be distributed among the multiple tenants/customers including a first subset of pods associated with requests from a first set of tenants, and a second subset of pods associated with requests from a second set of tenants.

14. The non-transitory computer readable storage medium of claim 11, wherein the tying of an RDG agent of a particular tenant, and the querying of the database by the agent/server; and the tying of the original request, and eventual response, is provided by the RDG protocol.

15. The non-transitory computer readable storage medium of claim 11, wherein a consistent-hashing scheme can be used in combination with a specific key in the header to determine which subset of pods to connect to; and to maintain, for the duration of processing several requests from multiple tenants, a connection to each of the RDG microservice pods simultaneously.
